(19) United States
(12) Patent Application Publication
(10) Pub. No.: US 2011/0070747 A1
(43) Pub. Date: Mar. 24, 2011

(54) Communications/Audio Interface with Self-Orienting Magnet Attachment System

(75) Inventor: Geoffrey R. Ball, Axams (AT)

(73) Assignee: MED-EL ELEKTROMEDIZINISCHE GERAETE GMBH, Innsbruck (AT)

(21) Appl. No.: 12/886,753

(22) Filed: Sep. 21, 2010

Related U.S. Application Data
(60) Provisional application No. 61/244,598, filed on Sep. 22, 2009.

(51) Int. Cl. H01R 11/30

(52) U.S. Cl. 439/39

(57) ABSTRACT

An electronic connection device is described. A magnetic connector interface has at least two adjacent magnetic interface elements. One is a north wiring interface element having an outer surface with a north magnetic field orientation and at least one wiring contact for providing electrical connection to at least one north electrical wire. The other interface element is a south wiring interface element having an outer surface with a south magnetic field orientation and at least one wiring contact for providing electrical connection to at least one south electrical wire.

This application claims priority from U.S. Provisional patent application 61/244,598, filed Sep. 22, 2009, which is incorporated herein by reference.

### FIELD OF THE INVENTION

The present invention relates to communications systems, specifically, to a useful wiring connector for such systems.

### BACKGROUND ART

It has been said that we now live in a wired world. One ubiquitous device is the MP3 player where a small electronic device generates a user audio signal and resides in a convenient pocket of the user. The audio signal from the MP3 player is delivered by wires to ear buds in the ear canal of the user for hearing. These wires loosely flop around about the user's body and are subject to frequent undesirable snagging on the user's own body and that of structures in the near vicinity. Snagged wires can cause various undesired effects such as roughly snatching the ear buds out of the ear canal, ripping the MP3 player out of place to fall on the ground, knocking off glasses of the user, etc. And the wires and their connectors can also be broken by such snags.

### SUMMARY OF THE INVENTION

Embodiments of the present invention are directed to an electronic connection device. A magnetic connector interface has at least two adjacent magnetic interface elements. One is a north wiring interface element having an outer surface with a north magnetic field orientation and at least one wiring contact for providing electrical connection to at least one north electrical wire. The other interface element is a south wiring interface element having an outer surface with a south magnetic field orientation and at least one wiring contact for providing electrical connection to at least one south electrical wire.

In further specific embodiments, the magnetic interface elements may be asymmetrically arranged with respect to a central radial axis of the magnetic connector. Some embodiments may also include one or more non-wired magnetic interface elements adjacent to the wiring interface elements without a wiring contact. The wiring interface elements may be coaxially arranged such that one of the wiring interface elements forms a radial ring around the other wiring interface element. And the electrical wires may include audio signal wires (e.g., in a stereo audio arrangement) and/or digital data signal wires.

### BRIEF DESCRIPTION OF THE DRAWINGS

FIG. 1 shows an example of one specific application of a magnetic connector interface according to an embodiment of the present invention.

FIG. 2 shows various structural details of a magnetic connector according to an embodiment of the present invention.

FIG. 3 shows various structural details of a mono audio magnetic connector according to an embodiment of the present invention.

FIG. 4 shows various structural details of a stereo audio magnetic connector according to an embodiment of the present invention.

### DETAILED DESCRIPTION OF SPECIFIC EMBODIMENTS

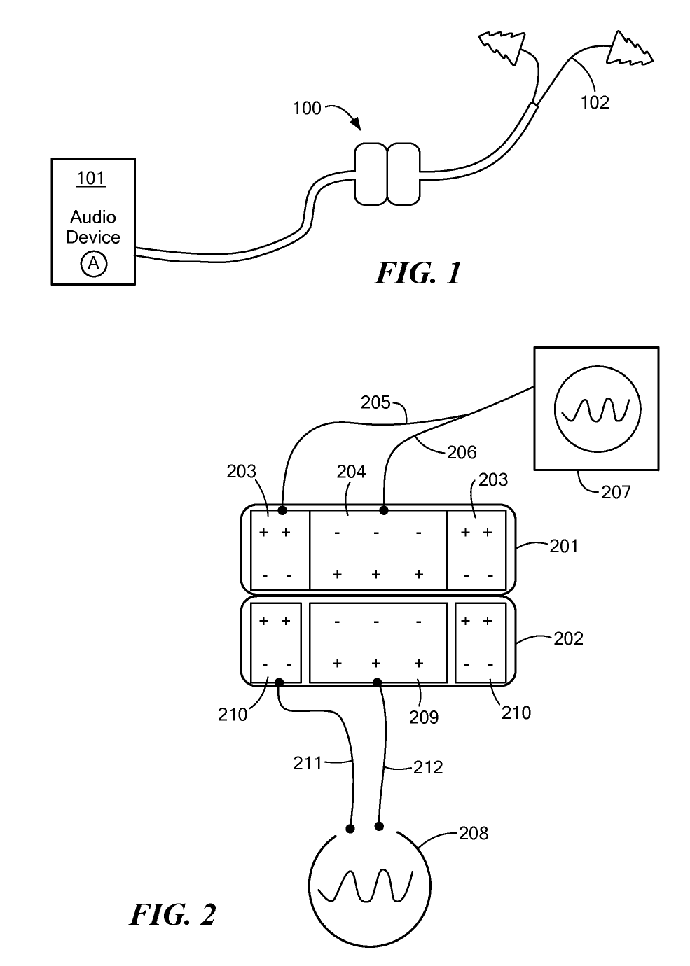

Embodiments of the present invention are directed to an electronic connection device. FIG. 1 shows an example of one specific application of a magnetic connector interface device according to an embodiment of the present invention where a magnetic connector interface 100 connects the wires delivering a user audio signal from an audio device 101 such as an MP3 player to user ear buds 102 that reproduce the audio signal in the ear canal of the user for hearing. The wires may include audio signal wires (e.g., in a stereo audio arrangement) and/or digital data signal wires.

FIG. 2 shows various structural details of a magnetic connector according to an embodiment of the present invention. An output magnetic connector interface 201 is associated with an output device 207 (e.g., ear buds) and has an output center wiring interface element 204 having an outer surface with a north magnetic field orientation which also acts as a wiring contact to provide an electrical connection to an output center electrical wire 206. Surrounding the output center wiring interface element 204 is an output radial ring wiring interface element 203 having an outer surface with a south magnetic field orientation which also acts as a wiring contact to provide an electrical connection to an output outer electrical wire 205. There is also a corresponding input magnetic connector interface 202 that is associated with an input device 208 (e.g., MP3 player) which has an input center wiring interface element 209 having an outer surface with a south magnetic field orientation which also acts as a wiring contact to provide an electrical connection to an input center electrical wire 212. Radially surrounding the input center wiring interface element 209 is a complementary input outer wiring interface element 210 having an outer surface with a north magnetic field orientation which also acts as a wiring contact to provide an electrical connection to an input outer electrical wire 211.

When the input magnetic connector 202 and the output magnetic connector 201 are brought close together, they magnetically self-orient to magnetically connect the center wiring interface elements 204 and 209 together and the outer ring interface elements 203 and 210. This electrically connects the center wires 206 and 212 and the outer wires 205 and 211. The interface between the center wiring elements 204/209 and the outer ring interface elements 203/210 may include an electrical insulator film to keep electrical separation between the corresponding center and outer wires 205/206 and 211/212. Ideally, the magnetic attraction forces are controlled to be just strong enough to maintain a secure mechanical connection between the two connectors 201 and 202, while being weak enough to allow the connectors to easily separate under sudden stress such as from a snagging of the wires.

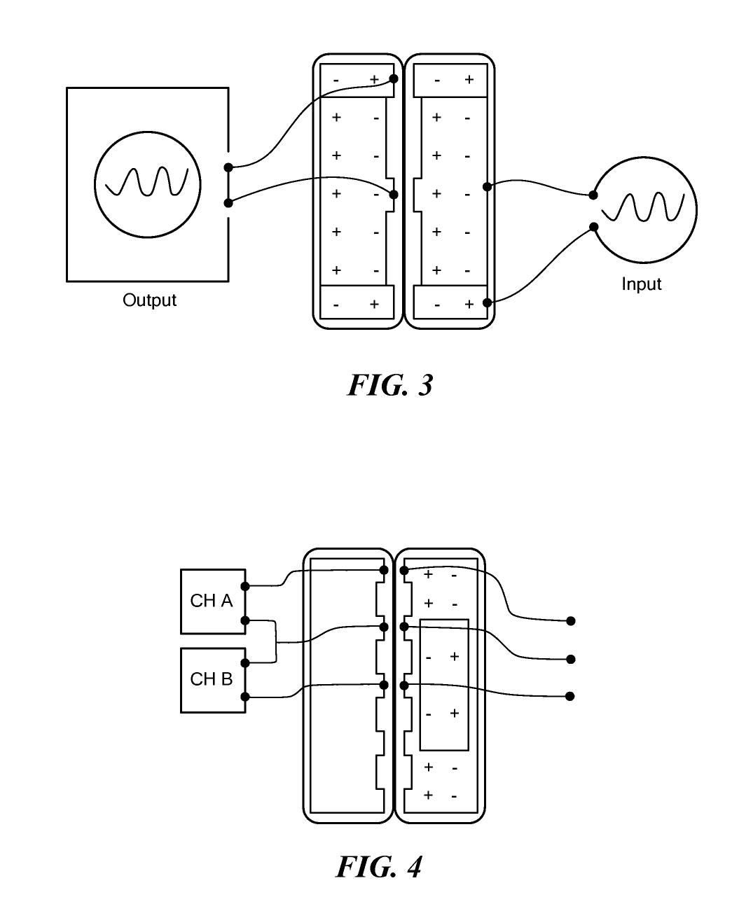

FIG. 3 shows various structural details of a mono audio magnetic connector according to an embodiment of the present invention. FIG. 4 shows various structural details of a stereo audio magnetic connector according to an embodiment of the present invention. Instead of a coaxial arrangement of wiring interface elements, the magnetic interface elements in these embodiments are asymmetrically arranged with respect to a central radial axis. In addition, there also are non-wired magnetic interface elements adjacent to the wiring interface elements without a wiring contact. This radially asymmetric arrangement aids in ensuring an electrically correct self-orienting of the magnetic connectors when they are brought together.

Although various exemplary embodiments of the invention have been disclosed, it should be apparent to those skilled in the art that various changes and modifications can be made which will achieve some of the advantages of the invention without departing from the true scope of the invention.

What is claimed is:

1. An electronic connection device comprising:
a magnetic connector interface having at least two adjacent magnetic interface elements including:
i. a north wiring interface element having an outer surface with a north magnetic field orientation and at least one wiring contact for providing electrical connection to at least one north electrical wire, and
ii. a south wiring interface element having an outer surface with a south magnetic field orientation and at least one wiring contact for providing electrical connection to at least one south electrical wire.

2. An electronic connection device according to claim 1, wherein the magnetic connector interface includes a central radial axis, and wherein the magnetic interface elements are asymmetrically arranged with respect to the central radial axis.

3. An electronic connection device according to claim 1, further comprising:
a non-wired magnetic interface element adjacent to the wiring interface elements without a wiring contact.

4. An electronic connection device according to claim 1, wherein the wiring interface elements are coaxially arranged such that one of the wiring interface elements forms a radial ring around the other wiring interface element.

5. An electronic connection device according to claim 1, wherein the electrical wires include audio signal wires.

6. An electronic connection device according to claim 5, wherein the audio signal wires have a stereo audio arrangement.

7. An electronic connection device according to claim 1, wherein the electrical wires include digital data signal wires.
